(19) United States
(12) Patent Application Publication
(10) Pub. No.: US 2024/0239944 A1
(43) Pub. Date: Jul. 18, 2024

(54) Production of a Blocked Curing Agent Based on a Partly Organic-Based Polyisocyanate and Use as a 1K PUR Baking Enamel

(71) Applicant: Covestro Deutschland AG, Leverkusen (DE)

(72) Inventors: Bernadette Gerhartz-Quirin, Leverkusen (DE); Alonso Rondon Tello, Düsseldorf (DE); Anne Kutz, Korschenbroich (DE); Arjan Elskamp, Epe (NL); Berta Vega Sanchez, Köln (DE); Florian Stempfle, Köln (DE); Frino Wiedenhof, Emmen (NL); Pantea Nazaran, Leverkusen (DE)

(21) Appl. No.: 18/690,619

(22) PCT Filed: Sep. 8, 2022
(86) PCT No.: PCT/EP2022/074958

§ 371 Date: Mar. 8, 2024

(30) Foreign Application Priority Data
Sep. 9, 2021 (EP) 21195815.2

(51) Int. Cl. C08G 18/10; C09D 7/20; C09D 7/61; C09D 7/63; C09D 7/65; C09D 167/00

(52) U.S. Cl. CPC C08G 18/10; C09D 7/20; C09D 7/61; C09D 7/63; C09D 7/65; C09D 167/00; C08G 2150/00

(57) ABSTRACT

The invention relates to a polyisocyanate composition including an isocyanate group-containing formative component, the isocyanate groups being reacted to ≥50% with at least one isocyanate group-reactive compound which includes at least one N—R¹ group, R¹ being selected from H or OH and N being connected to the other atoms of the compound via two single bonds or a double bond, where the formative component is formed by up to ≥51 wt. % of at least one polyisocyanate based on 1,5-pentamethylene diisocyanate having an isocyanurate trimer content of ≤60 area. %, based on the total weight of the polyisocyanates based on 1,5-pentamethylene diisocyanate and determined by means of gel permeation chromatography in accordance with DIN 55672-1:2007-08, and the proportion, missing by up to 100 wt. %, of the total amount of polyisocyanates contained in the formative component includes or consists of at least one aliphatic or cycloaliphatic polyisocyanate.

### CROSS-REFERENCE TO RELATED APPLICATIONS

This application is the United States national phase of International Application No. PCT/EP2022/074958 filed Sep. 8, 2022, and claims priority to European Patent Application No. 21195815.2 filed Sep. 9, 2021, the disclosures of which are hereby incorporated by reference in their entireties.

### BACKGROUND

### Technical Field

The invention relates to a polyisocyanate composition comprising an isocyanate group-containing formation component, where the isocyanate groups have been reacted to an extent of ≥50% with at least one isocyanate group-reactive compound which comprises at least one N—R¹ group, where R¹ is selected from H or OH and N is bonded to the other atoms of the compound via two single bonds or a double bond, characterized in that the formation component is formed to an extent of ≥51% by weight from at least one polyisocyanate based on pentamethylene 1,5-diisocyanate having a content of isocyanurate trimer of ≤60 area %, based on the total weight of the polyisocyanates based on pentamethylene 1,5-diisocyanate and determined by gel permeation chromatography in accordance with DIN 55672-1:2007-08, and the remainder to 100% by weight of the total amount of polyisocyanates present in the formation component comprises or consists of at least one aliphatic or cycloaliphatic polyisocyanate. The invention further relates to the use of this polyisocyanate composition for the production of a one-component system, and to a one-component system comprising this polyisocyanate composition and at least one polyol. In addition, the invention relates to a process for producing a coating on a substrate, in which a one-component system according to the invention is applied to the substrate and cured at a temperature in the range from 80° C. to 300° C., and to the coating thus produced. The invention finally relates to a composite composed of a coating of the present invention and a substrate having a surface of metal and/or plastic.

### Description of Related Art

Coatings based on polyisocyanate compositions are known and commercially available. One representative of these are HDI (hexamethylene 1,6-diisocyanate)-based compositions (for example based on Desmodur® N3300, commercially available from Covestro AG) in which isocyanate groups are blocked, for example with N-containing azole compounds, in order to improve the storage stability and handling of coating systems, among other reasons. However, such products exhibit relatively low hardness as well as low weathering stability.

### SUMMARY

The object of the present invention was therefore to provide a polyisocyanate composition having partially blocked isocyanate groups that overcomes the above-described disadvantages.

The inventors of the present invention have surprisingly found that this can be achieved using the specific polyisocyanate composition of the present invention based on PDI (pentamethylene 1,5-diisocyanate) blocked with at least one isocyanate group-reactive compound which comprises at least one N—R¹ group, where R¹ is selected from H or OH and N is bonded to the other atoms of the compound via two single bonds or a double bond. A more sustainable composition is therefore also provided.

This is particularly surprising since, for PDI-based compositions blocked with CH-acidic reagents, the introductory section of WO 2017/021150 A1 describes that it is assumed that disadvantages would be expected in the case of an additional use of oximes or 3,5-dimethylpyrazole with PDI-based polyisocyanate. Furthermore, the present compositions are advantageous since, in contrast to the composition described in said document, no crystallization inhibitors are needed.

Therefore, the present invention relates in a first aspect to a polyisocyanate composition comprising an isocyanate group-containing formation component, where the isocyanate groups have been reacted to an extent of ≥50%, preferably ≥60%, more preferably ≥70%, most preferably ≥80%, ≥90% or ≥95%, with at least one isocyanate group-reactive compound which comprises at least one N—R¹ group, where R¹ is selected from H or OH and N is bonded to the other atoms of the compound via two single bonds or a double bond, characterized in that the formation component is formed to an extent of ≥51% by weight from at least one polyisocyanate based on pentamethylene 1,5-diisocyanate having a content of isocyanurate trimer of ≤60 area %, based on the total weight of the polyisocyanates based on pentamethylene 1,5-diisocyanate and determined by gel permeation chromatography in accordance with DIN 55672-1:2007-08, and the remainder to 100% by weight of the total amount of polyisocyanates present in the formation component comprises or consists of at least one aliphatic or cycloaliphatic polyisocyanate.

In a second aspect, the present invention relates to the use of a polyisocyanate composition according to the present invention for the production of a one-component system, in particular a one-component coating system.

In a third aspect, the present invention relates to a one-component system comprising at least one polyisocyanate composition according to the present invention, at least one polyol and optionally further additives.

In a fourth aspect, the present invention relates to a process for producing a coating on a substrate, in which a one-component system of the present invention is applied to the substrate and cured at a temperature in the range from 80° C. to 300° C., preferably in the range from 90° C. to 250° C.

In a fifth aspect, the present invention relates to a coating produced or producible by a process according to the present invention.

Finally, the present invention relates in a sixth aspect to a composite composed of a coating according to the present invention and a substrate having a surface of metal and/or plastic.

### DETAILED DESCRIPTION

According to the present invention, trimer structures are understood to mean the following isocyanurate structural units which are formed from diisocyanates and are randomly linked to one another according to the oligomeric distribution:

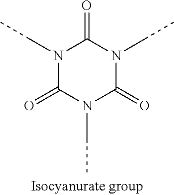

The specification of the content of isocyanurate trimer as proportion by weight based on the total weight of the respective polyisocyanates refers according to the invention to the compounds in the polyisocyanate composition which comprise exactly one isocyanurate group and three isocyanate groups. The content of isocyanurate trimer is determined as area percent (area %) by gel permeation chromatography (GPC) in accordance with DIN 55672-1:2007-08.

In a first preferred embodiment, the formation component consists to an extent of at least 60% by weight, preferably to an extent of at least 70% by weight and particularly preferably to an extent of at least 80% by weight of at least one polyisocyanate based on pentamethylene 1,5-diisocyanate having a content of isocyanurate trimer of ≤60 area %, based on the total weight of the polyisocyanates based on pentamethylene 1,5-diisocyanate. This results, inter alia, in the advantage that the storage stability can be further increased.

This additionally results in the advantage that the biobased proportion of the polyisocyanate composition according to the invention can be further increased. It is therefore very particularly preferred in this case if the formation component consists to an extent of 100% by weight of at least one polyisocyanate based on pentamethylene 1,5-diisocyanate.

In a further preferred embodiment, the content of isocyanurate trimer is ≥36 area % and ≤56 area %, preferably ≥38 area % and ≤51 area %, based on the total weight of the polyisocyanates based on pentamethylene 1,5-diisocyanate.

According to a further preferred embodiment, the remainder to 100% by weight of the total amount present in the formation component consists of at least one aliphatic or cycloaliphatic polyisocyanate and is at least 5% by weight, preferably at least 10% by weight and particularly preferably at least 15% by weight.

The polyisocyanates based on pentamethylene 1,5-diisocyanate are any desired oligomeric polyisocyanates that are obtainable by modification of pentamethylene 1,5-diisocyanate (PDI) and have uretdione, isocyanurate, allophanate, biuret, iminooxadiazinedione and/or oxadiazinetrione structure or any desired mixtures of such polyisocyanates. These polyisocyanates are prepared by methods known per se for isocyanate oligomerization, as described for example in J. Prakt. Chem. 336 (1994) 185-200 and EP 0 798 299 A1, by reacting some of the isocyanate groups in the PDI to form polyisocyanate molecules consisting of at least two diisocyanate molecules, and a generally subsequent distillative or extractive removal of the unreacted monomeric PDI.

The PDI used for preparing the polyisocyanates based on pentamethylene 1,5-diisocyanate is obtainable in various ways, for example by phosgenation in the liquid or gas phase or by a phosgene-free route, for example by thermal urethane cleavage proceeding from 1,5-diaminopentane obtained preferably by means of biotechnology via decarboxylation of the naturally occurring amino acid lysine.

The isocyanurate trimer content can be adjusted by appropriate reaction regime and thus the trimerization reaction is preferably terminated after reaching the desired isocyanurate trimer content. This may be accomplished, for example, by cooling the reaction mixture to room temperature. Generally, however, the reaction is ended by adding one or more catalyst poisons known to those skilled in the art and optionally subsequent brief heating of the reaction mixture, for example to a temperature above 80° C.

The aliphatic or cycloaliphatic polyisocyanates which differ from polyisocyanates based on pentamethylene 1,5-diisocyanate are any desired oligomeric polyisocyanates that are obtainable by modification of suitable monomeric diisocyanates and have uretdione, isocyanurate, allophanate, biuret, iminooxadiazinedione and/or oxadiazinetrione structure or any desired mixtures of such polyisocyanates. These polyisocyanates are prepared by methods known per se for isocyanate oligomerization, as described by way of illustration for example in J. Prakt. Chem. 336 (1994) 185-200, by reacting some of the isocyanate groups in the monomeric diisocyanates to form polyisocyanate molecules consisting of at least two diisocyanate molecules, and a generally subsequent distillative or extractive removal of the unreacted monomeric diisocyanates.

Suitable monomeric diisocyanates are especially those from the molecular weight range of 140 to 400, such as 1,4-diisocyanatobutane, hexamethylene 1,6-diisocyanate (HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 2,4- and 2,6-diisocyanato-1-methylcyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 4,4′-diisocyanatodicyclohexylmethane, 2,4′-diisocyanatodicyclohexylmethane, 1-isocyanato-1-methyl-4(3)isocyanatomethylcyclohexane, bis(isocyanatomethyl)norbornane. 1,3- and 1,4-bis(isocyanatomethyl)benzene (XDI) or any desired mixtures of such diisocyanates. It is generally preferred if the residual monomer content of monomeric diisocyanates in the polyisocyanate composition according to the invention is below 0.5% by weight, particularly preferably below 0.3% by weight. The residual monomer contents can be determined for example by gas chromatography in accordance with DIN EN ISO 10283:2006-04.

It is further preferable that the remainder to 100% by weight of the total amount of polyisocyanates present in the formation component consists of at least one aliphatic polyisocyanate.

In a preferred embodiment, the at least one isocyanate group-reactive compound is selected from N-containing azole compounds, oximes, amines or lactams or mixtures thereof; more preferably, it is selected from pyrazoles, ketoximes, secondary amines or lactams or mixtures thereof; particularly preferably, it is selected from 3,5-dimethylpyrazole, 3,5-diisopropylpyrazole, 3,5-di-tert-butylpyrazole, 3,5-diphenylpyrazole, butanone oxime, 2-pentanone oxime, cyclohexanone oxime, 4-methyl-2-pentanone oxime, diisopropylamine, N-benzyl-tert-butylamine or ε-caprolactam or mixtures thereof; most preferably, the compound is 3,5-dimethylpyrazole or butanone oxime.

Alternatively or additionally, it is preferable that the at least one isocyanate group-reactive compound is not a piperidone-based compound of the general formula (1),

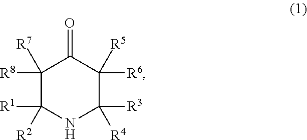

in which each of the radicals R¹ to R⁴ is an alkyl group having 1 to 4 carbon atoms, R¹ to R⁴ may here be identical or different to one another, and each of the radicals R⁵ to R⁸ is an alkyl group having 1 to 4 carbon atoms or hydrogen, R⁵ to R⁸ may here be identical or different to one another.

Alternatively or additionally, it is preferable that the at least one isocyanate group-reactive compound is not a piperidone-based compound of EP 3 950 759 A1.

The later deblocking of the blocking group formed from these compounds is performed at 80° C. to 300° C. In addition to the isocyanate group-containing formation component and the blocking compound, the polyisocyanate composition according to the invention may also comprise further compounds.

In general, the polyisocyanate composition according to the invention may be present free of solvents, but it is also possible for one or more solvents inert to the reactive groups of the components used to be present.

Suitable solvents are for example the customary coatings solvents which are known per se, such as ethyl acetate, butyl acetate, ethylene glycol monomethyl or monoethyl ether acetate, 1-methoxy-2-propyl acetate, 3-methoxy-n-butyl acetate, acetone, 2-butanone, 4-methyl-2-pentanone, cyclohexanone, toluene, xylene, chlorobenzene, white spirit, relatively highly substituted aromatics, such as those commercialized for example under the names solvent naphtha, Solvesso®, Isopar®, Nappar®, Varsol® (ExxonMobil Chemical Central Europe, Cologne, DE) and Shellsol® (Shell Deutschland Oil GmbH, Hamburg, DE), but also solvents such as propylene glycol diacetate, diethylene glycol dimethyl ether, dipropylene glycol dimethyl ether, diethylene glycol ethyl and butyl ether acetate, N-methylpyrrolidone and N-methylcaprolactam, or any desired mixtures of such solvents.

In a further preferred embodiment, the polyisocyanate composition according to the invention comprises at least one organic solvent, preferably solvent naphtha, such as solvent naphtha 100, methoxypropyl acetate, butyl acetate, xylene and mixtures thereof, particularly preferably solvent naphtha 100, methoxypropyl acetate and mixtures thereof.

By choosing the amount of solvent, the solids content of the polyisocyanate composition according to the invention can be varied within wide limits in the case of the preferred accompanying use of organic solvents. It is very particularly preferred in this case if the polyisocyanate composition according to the invention has a solids content of ≥10% and ≤95% by weight, preferably of ≥25% and ≤85% by weight.

The polyisocyanate composition according to the invention is obtained by reacting the isocyanate groups of the polyisocyanates present in the isocyanate group-containing formation component with the at least one reactive compound mentioned above.

By means of the reaction, the isocyanate groups of the polyisocyanates are converted into stable adducts which result in storage-stable mixtures with polyols at room temperature. At temperatures of ≥80° C., the blocking agent releases the isocyanate group for crosslinking with the polyol component.

The polyisocyanate composition according to the invention is therefore very well suited for the production of a one-component system, and thus such use is further provided by the invention. For this purpose, the polyisocyanate composition according to the invention is mixed with further compounds described below.

The invention further provides a one-component system comprising at least one polyisocyanate composition according to the invention, at least one polyol and optionally further additives. The one-component system according to the invention is advantageously distinguished by greater hardness and weathering stability in comparison with conventional, blocked one-component systems.

Suitable polyols are for example polyether polyols, polyester polyols, polycarbonate polyols or polyacrylate polyols.

Any additives present may for example be the following that are known to those skilled in the art: cobinders, desiccants, fillers, cosolvents, color or effect pigments, thickeners, matting agents, light stabilizers, coatings additives, such as dispersants, thickeners, defoamers, and other additives, such as adhesives, fungicides, bactericides, stabilizers or inhibitors, and catalysts or emulsifiers.

The invention further provides a process for producing a coating on a substrate, in which the one-component system according to the invention is applied to the substrate and cured at a temperature from 80° C. to 300° C.

The one-component system according to the invention can be applied by known methods, for example by spraying, painting, flow coating or with the aid of rollers or doctor blades onto any desired substrates. Examples of suitable substrates include metal, glass, stone, ceramic materials, concrete, plastics, composites, textiles, leather or paper, which may optionally also be provided with customary primers prior to coating. Particularly preferred substrates are substrates having a surface of metal and/or plastic.

The invention therefore further provides a coating produced or producible by the process according to the invention.

As well as the coating itself, the invention further provides a composite composed of the coating according to the invention and a substrate having a surface of metal and/or plastic.

The invention especially relates to the following embodiments:
1. According to a first embodiment, the invention relates to a polyisocyanate composition comprising an isocyanate group-containing formation component, where the isocyanate groups have been reacted to an extent of ≥50% with at least one isocyanate group-reactive compound which comprises at least one N—R¹ group, where R¹ is selected from H or OH and N is bonded to the other atoms of the compound via two single bonds or a double bond, characterized in that the formation component is formed to an extent of ≥51% by weight from at least one polyisocyanate based on pentamethylene 1,5-diisocyanate having a content of isocyanurate trimer of ≤60 area %, based on the total weight of the polyisocyanates based on pentamethylene 1,5-diisocyanate and determined by gel permeation chromatography in accordance with DIN 55672-1:2007-08, and the remainder to 100% by weight of the total amount of polyisocyanates present in the formation component comprises or consists of at least one aliphatic or cycloaliphatic polyisocyanate.
2. The polyisocyanate composition according to embodiment 1, characterized in that the formation component is formed to an extent of at least 60% by weight from at least one polyisocyanate based on pentamethylene 1,5-diisocyanate having a content of isocyanurate trimer of ≤60 area %, based on the total weight of the polyisocyanates based on pentamethylene 1,5-diisocyanate.
3. The polyisocyanate composition according to embodiment 1 or 2, characterized in that the content of isocyanurate trimer is ≥36 area % and ≤56 area %, based on the total weight of the polyisocyanates based on pentamethylene 1,5-diisocyanate.
4. The polyisocyanate composition according to any of the preceding embodiments, characterized in that the remainder to 100% by weight of the total amount of polyisocyanates present in the formation component consists to an extent of at least 5% by weight of the aliphatic or cycloaliphatic polyisocyanate.
5. The polyisocyanate composition according to any of the preceding embodiments, characterized in that the at least one isocyanate group-reactive compound is not a piperidone-based compound of the general formula (1),

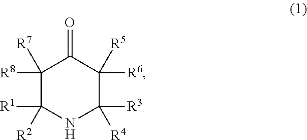

in which each of the radicals R¹ to R⁴ is an alkyl group having 1 to 4 carbon atoms, R¹ to R⁴ may here be identical or different to one another, and each of the radicals R⁵ to R⁸ is an alkyl group having 1 to 4 carbon atoms or hydrogen, R⁵ to R⁸ may here be identical or different to one another.
6. The polyisocyanate composition according to any of the preceding embodiments, characterized in that the at least one isocyanate group-reactive compound is selected from N-containing azole compounds, oximes, amines or lactams or mixtures thereof.
7. The polyisocyanate composition according to any of the preceding embodiments, characterized in that the at least one isocyanate group-reactive compound is selected from pyrazoles, ketoximes, secondary amines or lactams or mixtures thereof.
8. The polyisocyanate composition according to any of the preceding embodiments, characterized in that the at least one isocyanate group-reactive compound is selected from 3,5-dimethylpyrazole, 3,5-diisopropylpyrazole, 3,5-di-tert-butylpyrazole, 3,5-diphenylpyrazole, butanone oxime, 2-pentanone oxime, cyclohexanone oxime, 4-methyl-2-pentanone oxime, diisopropylamine, N-benzyl-tert-butylamine, ε-caprolactam or mixtures thereof.
9. The polyisocyanate composition according to any of the preceding embodiments, characterized in that the remainder to 100% by weight of the total amount of polyisocyanates present in the formation component consists of the at least one aliphatic polyisocyanate.
10. The polyisocyanate composition according to any of the preceding embodiments, characterized in that the polyisocyanate composition comprises at least one organic solvent.
11. The use of a polyisocyanate composition according to any of embodiments 1 to 10 for the production of a one-component system.
12. A one-component system comprising at least one polyisocyanate composition according to any of embodiments 1 to 10, at least one polyol and optionally further additives.
13. A process for producing a coating on a substrate, in which a one-component system according to embodiment 12 is applied to the substrate and cured at a temperature in the range from 80° C. to 300° C.
14. A coating produced or producible by a process according to embodiment 13.
15. A composite composed of a coating according to embodiment 14 and a substrate having a surface of metal and/or plastic.

The invention is elucidated in more detail below using examples which however are not to be interpreted as limiting.

### Examples

All percentages are based on weight, unless stated otherwise.

NCO contents were determined titrimetrically in accordance with DIN EN ISO 11909:2007-05.

All viscosity measurements were made with an MCR302 from Anton Paar Germany GmbH (DE) in accordance with DIN EN ISO 3219:1994-10.

The color number was measured by spectrophotometry in accordance with DIN EN 1557:1996 with a LICO 690 spectral colorimeter from Lange, DE.

Solvent and water resistances were determined in accordance with DIN EN ISO 4628-1:2016-07.

The nonvolatile fraction (NVF) is measured in accordance with DIN EN ISO 3251:2019.

Measurement of the renewable fraction by means of isotope analysis was performed in accordance with ASTM-D6866-20.

### LIST OF TRADE NAMES AND ABBREVIATIONS

Products from Covestro

### Desmodur® N 3300

Aliphatic polyisocyanate (HDI isocyanurate), as-supplied form 100%
NCO content: 21.8%
Viscosity approx. 3000 mPas at 23° C.

### Desmodur® Eco N 7300

Aliphatic polyisocyanate (PDI isocyanurate), as-supplied form 100%
NCO content: 21.75%
Viscosity approx. 9500 mPas at 23° C.

### Uralac® SN844 S2G3-60ND

Saturated polyester, as-supplied form 60% in solvent naphtha 150ND/butyl glycol (30/10)
OHN: 30-35 mg KOH/g
Viscosity 2.8-3.2 Pas at 23° C.
Dimethylpyrazole was obtained from Wacker Chemie AG (DE).
Acetylacetone was obtained from Daicel Chemical Industries, Ltd. (Japan).
Hydrazine hydrate was obtained from Merck KGaA Germany.
Solvent naphtha 100 was obtained from Brenntag GmbH.
Methoxypropyl acetate was obtained from OQema GmbH.
Solvent naphtha 150 ND was obtained from DHC.
Butyl glycol was obtained from Brenntag GmbH.
Kronos 2360 (titanium dioxide) was obtained from Kronos.
Dibutyltin dilaurate was obtained from D B Becker Co Inc.
Urad dd27 ND (acrylate polymer as surface additive) was obtained from Synres B.V.

### Comparative Example 1 (Comparative Example)

260 g of acetylacetone is initially charged with the appropriate amount of solvent. Nitrogen is introduced and the mixture is heated to 70° C. 130 g of hydrazine hydrate is added dropwise over a period of 30 minutes. During the exothermic reaction, the reaction temperature rises to 95-98° C. The reaction temperature is increased to 150° C. during the separation of water until the water separation is complete. The reaction is cooled to 73ºC and 501 g of Desmodur N® 3300 is metered in in portions. The reaction temperature rises to 90° C. The mixture is stirred until the theoretical NCO content of 0.0% by weight has been reached. After cooling to room temperature, the characteristic data viscosity, color number and nonvolatile fraction are determined:
Viscosity: 4300 mPas at 23° C.
Color number: ≤100 Hz
Nonvolatile fraction: 75±2%
Blocked NCO content: 10.5%
Renewable fraction: 0%

### Example 1 (Example According to the Invention)

501 g of Desmodur® eco N 7300 is initially charged under nitrogen with the appropriate amount of solvent and heated to 50° C. Subsequently, 249 g of dimethylpyrazole is metered in in portions over the course of 2 hours, the solid is dissolved and the mixture is stirred at 70° C. until the theoretical NCO content of 0.0% by weight has been reached.

After cooling to room temperature, the characteristic data viscosity, color number and nonvolatile fraction are determined:
Viscosity: 8500 mPas at 23° C.
Color number: ≤100 Hz
Nonvolatile fraction: 75±2%
Blocked NCO content: 10.9%
Renewable fraction: 32%

### Coating Tests:

All percentages are based on weight, unless otherwise stated.
König pendulum damping was determined in accordance with DIN 53157, ISO 1522.
The gloss measurement is carried out in accordance with NEN-EN 13523-2:2014, ISO 2813.
The T-bend test was carried out in accordance with NEN-EN 13523-7:2014.
Pencil hardness was carried out in accordance with NEN-EN 13523-4:2014.
The color of the weathered coatings was measured in accordance with DIN EN ISO 11664 (Part 4).
Accelerated weathering is carried out in accordance with DIN EN ISO 16474-2, Method A, Cycle No. 1 (xenon).

### Use Examples (According to the Invention)

In order to examine the coating properties, a formulation based on the thermally activatable curing agents from Comparative Example 1 and Example 1 and in each case Uralac® SN844 S2G3 60 ND in an NCO:OH ratio of 1:1 was prepared. The solvent used was a mixture of solvent naphtha 150 ND and butyl glycol in the ratio 3:1. Details of the coating formulation are listed in Table 1.

These coating formulations were applied to an aluminum substrate using a doctor blade and baked at a peak metal temperature of 241° C. The layer thickness was 20-22 μm in all cases.

TABLE 1
Coating formulation composition

| | | Coating 2 |
|---|---|---|
| | Coating 1 | (according to |
| | (comp.) | the invention) |
| Uralac SN844 S2G3 60 ND | 17.71 | 17.88 |
| Kronos 2360 | 31.88 | 32.31 |
| Solv. 150 ND/butyl glycol | 7.08 | 7.19 |

Dispersion for 15 min at 2000 rpm, 10 min at 1000 rpm

| | | |
|---|---|---|
| Uralac SN844 S2G3 ND | 27.34 | 28.03 |
| Comparative Example 1 | 6.47 | |
| Example 1 | | 6.35 |
| DBTL (10% in solv 150 ND) | 1.87 | 0.95 |
| Urad dd27 (10% in solv 150 ND) | 0.32 | 0.32 |
| Solv. 150 ND/butyl glycol | 7.34 | 6.97 |

TABLE 2
Coating properties

| | |
|---|---|
| | Coating 2 |
| Coating 1 | (according to |
| (comp.) | the invention) |

| Gloss 20° | 97 | | 91 | |
|---|---|---|---|---|
| Gloss 60° | 99 | | 96 | |
| T-bend cracking | 0.5 | T | 0.5 | T |
| T-bend adhesion | 0 | T | 0 | T |
| T-bend 15 min at 80° C. | 0.5 | T | 0.5 | T |

| | | |
|---|---|---|
| Konig pendulum damping | 176 | 188 |
| Pencil hardness | H | 2H |
| Yellowing (Δb value) | −0.6 | −0.2 |
| MEK double rubs | 100 | 100 |

Both materials exhibit comparable properties with respect to flexibility. In relation to the hardness and weathering stability, the formulation based on Example 1 according to the invention exhibits better properties.

1. A polyisocyanate composition comprising an isocyanate group-containing formation component, where the isocyanate groups have been reacted to an extent of ≥50% with at least one isocyanate group-reactive compound which comprises at least one N—R¹ group, where R¹ is selected from H or OH and N is bonded to the other atoms of the compound via two single bonds or a double bond, wherein the formation component is formed to an extent of ≥51% by weight from at least one polyisocyanate based on pentamethylene 1,5-diisocyanate having a content of isocyanurate trimer of ≤60 area %, based on the total weight of the polyisocyanates based on pentamethylene 1,5-diisocyanate and determined by gel permeation chromatography in accordance with DIN 55672-1:2007-08, and the remainder to 100% by weight of the total amount of polyisocyanates present in the formation component comprises or consists of at least one aliphatic or cycloaliphatic polyisocyanate.

2. The polyisocyanate composition as claimed in claim 1, wherein the formation component is formed to an extent of at least 60% by weight from at least one polyisocyanate based on pentamethylene 1,5-diisocyanate having a content of isocyanurate trimer of ≤60 area %, based on the total weight of the polyisocyanates based on pentamethylene 1,5-diisocyanate.

3. The polyisocyanate composition as claimed in claim 1, wherein the content of isocyanurate trimer is ≥36 area % and ≤56 area %, based on the total weight of the polyisocyanates based on pentamethylene 1,5-diisocyanate.

4. The polyisocyanate composition as claimed in claim 1, wherein the remainder to 100% by weight of the total amount of polyisocyanates present in the formation component consists to an extent of at least 5% by weight of the aliphatic or cycloaliphatic polyisocyanate.

5. The polyisocyanate composition as claimed in claim 1, wherein the at least one isocyanate group-reactive compound is selected from N-containing azole compounds, oximes, amines or lactams or mixtures thereof.

6. The polyisocyanate composition as claimed in claim 1, wherein the at least one isocyanate group-reactive compound is selected from pyrazoles, ketoximes, secondary amines or lactams or mixtures thereof.

7. The polyisocyanate composition as claimed in claim 1, wherein the at least one isocyanate group-reactive compound is selected from 3,5-dimethylpyrazole, 3,5-diisopropylpyrazole, 3,5-di-tert-butylpyrazole, 3,5-diphenylpyrazole, butanone oxime, 2-pentanone oxime, cyclohexanone oxime, 4-methyl-2-pentanone oxime, diisopropylamine, N-benzyl-tert-butylamine, ε-caprolactam or mixtures thereof.

8. The polyisocyanate composition as claimed in claim 1, wherein the remainder to 100% by weight of the total amount of polyisocyanates present in the formation component consists of the at least one aliphatic polyisocyanate.

9. The polyisocyanate composition as claimed in claim 1, wherein the polyisocyanate composition comprises at least one organic solvent.

10. A method for producing a one-component system comprising providing a polyisocyanate composition as claimed in claim 1.

11. A one-component system comprising at least one polyisocyanate composition as claimed in claim 1, at least one polyol and optionally further additives.

12. A process for producing a coating on a substrate, wherein a one-component system as claimed in claim 11 is applied to the substrate and cured at a temperature in the range from 80° C. to 300° C.

13. A coating produced or producible by a process as claimed in claim 12.

14. A composite composed of a coating as claimed in claim 13 and a substrate having a surface of metal and/or plastic.
